(19) United States
(12) Patent Application Publication
(10) Pub. No.: US 2020/0114920 A1
(43) Pub. Date: Apr. 16, 2020

(54) LIGHT-BASED LANE-CHANGE CONTROL

(71) Applicant: Ford Global Technologies, LLC, Dearborn, MI (US)

(72) Inventors: LINJUN ZHANG, Canton, MI (US); HELEN ELIZABETH KOUROUS-HARRIGAN, Monroe, MI (US)

(73) Assignee: Ford Global Technologies, LLC, Dearborn, MI (US)

(21) Appl. No.: 16/157,809

(22) Filed: Oct. 11, 2018

(51) Int. Cl. B60W 30/18; H04L 9/32; G05D 1/02

(52) U.S. Cl. CPC B60W 30/18163; H04L 9/3268; G05D 2201/0213; B60W 2550/40; G05D 1/0276

(57) ABSTRACT

Upon a determination to execute a lane change, a light-based request communication, including a security key, can be sent to a target vehicle to negotiate the lane change. Upon receiving a light-based response communication from the target vehicle, the lane change can be executed.

### BACKGROUND

It is a challenging problem for a vehicle, especially an autonomous vehicle, to be able to lane change lanes without experiencing, or incurring an unacceptable risk of, a collision. This is true whether vehicles in adjacent lanes are operated by a computer or by a human. Conventional sets of onboard sensors (e.g., camera, radar, LiDAR, etc.) cannot predict the motion or future paths of other vehicles with high certainty.

### BRIEF DESCRIPTION OF THE DRAWINGS

FIG. 1 is a diagram of an example vehicle-to-vehicle light-based communication system.

FIG. 2 is a block diagram of an example host vehicle.

FIG. 3 is a top view of an example light-based communications transceiver.

FIG. 4 is a diagram of an example process for a host vehicle to control a lane change including light-based communications.

FIG. 5 is a diagram of an example process for a target vehicle to provide light-based communications for a host vehicle to control a lane change including light-based communications.

### DESCRIPTION

A system can comprise a computer including a processor and a memory, the memory storing instructions executable by the processor to upon a determination to execute a lane change, send a light-based request communication, including a security key, to a target vehicle to negotiate the lane change; and upon receiving a light-based response communication from the target vehicle, execute the lane change. The security key can include a security certificate, an encoding rule, and an encryption rule. The instructions can further comprise instructions to receive at least a certificate in the security key from a roadside infrastructure element. The instructions can further comprise instructions to verify a signature received along with the security key from the roadside infrastructure element. The system can further comprise a roadside infrastructure element including a second computer including a second processor and a second memory, the second memory storing second instructions executable by the processor to generate and transmit the security key. The security key can be provided by non-light-based communications. The instructions can further comprise instructions to, prior to sending the light-based request communication, send a light-based handshake message. The instructions can further comprise instructions to send a lane change plan via light-based communications. The instructions can further comprise instructions to receive a response to the lane change plan via light-based communications. The instructions can further comprise instructions to cancel the lane change upon determining that a second target vehicle has priority in a target lane.

A method, can comprise upon a determination to execute a lane change, sending a light-based request communication, including a security key, to a target vehicle to negotiate the lane change; and upon receiving a light-based response communication from the target vehicle, executing the lane change. The security key can include a security certificate, an encoding rule, and an encryption rule. The method can further comprise receiving at least a certificate in the security key from a roadside infrastructure element. The method can further comprise verifying a signature received along with the security key from the roadside infrastructure element. The method can further comprise generating and transmitting the security key from a roadside infrastructure element. The security key can be provided by non-light-based communications. The method can further comprise, prior to sending the light-based request communication, sending a light-based handshake message. The method can further comprise sending a lane change plan via light-based communications. The method can further comprise receiving a response to the lane change plan via light-based communications. The method can further comprise canceling the lane change upon determining that a second target vehicle has priority in a target lane.

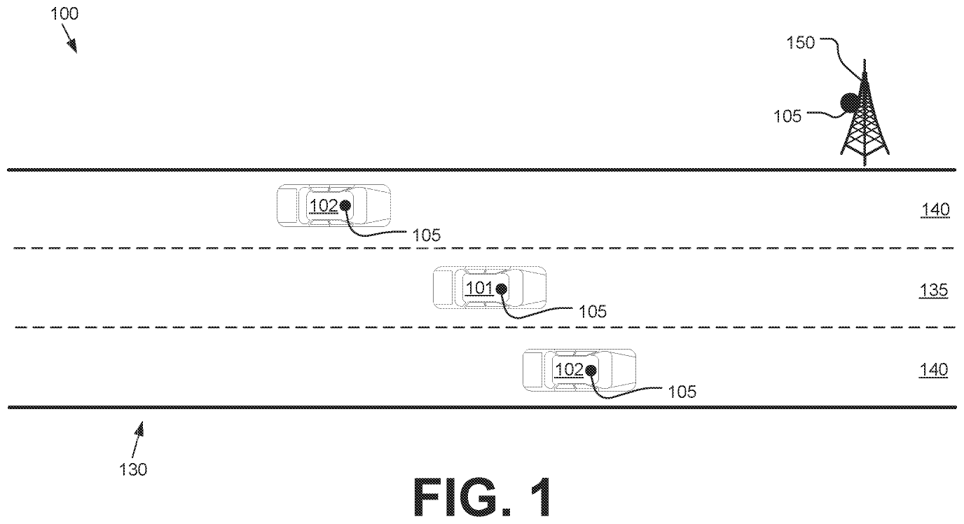

FIG. 1 is a diagram of an example vehicle-to-vehicle light-based communication system 100. A first vehicle 101 as well as one or more second vehicles 101 can be traveling in a same direction on respective lanes 135, 140 of a road 130. Each vehicle 101, 102, as well as an infrastructure element 150, can have mounted thereon a light-based communications transceiver 105. The infrastructure element 150 can from time to time update a security certificate maintained by each vehicle 101, 102. The vehicle 101, upon determining to change lanes, can initiate light-based communications with one or more other vehicles 101. The light-based communications can be authenticated with the security certificate. After the vehicles 101, 102 have established authenticity and security of light-based communications, then the communications between the vehicles 101, 102 can include communications to negotiate and/or plan a lane change of the vehicle 101.

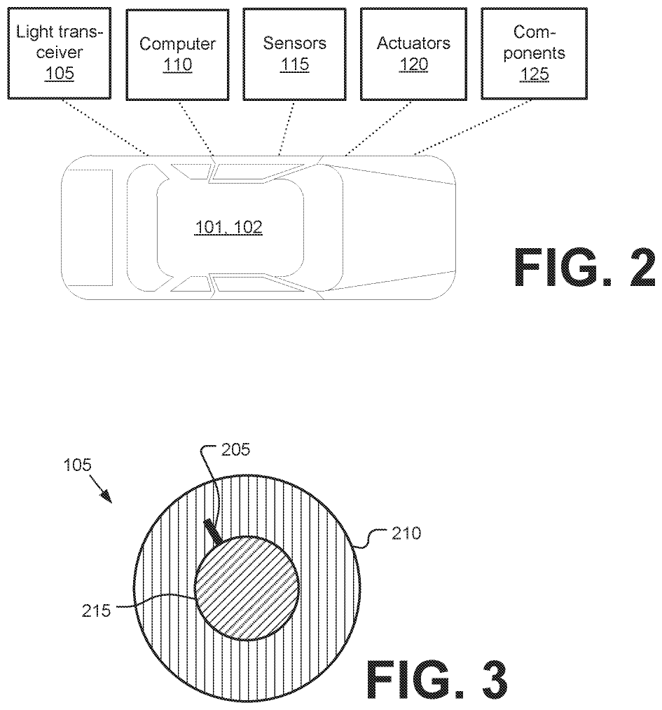

FIG. 2 is a block diagram of an example vehicle 101, 102 that typically includes a light transceiver 105, a computer 110, sensors 115, as well as actuators 120 that can actuate components 125. Vehicles 101, 102 are typically a machine-powered land vehicle such as a car, truck, etc. The vehicle 101 is sometimes referred to herein as a “host” vehicle 101 to differentiate the vehicle 101 from other vehicles 102, i.e., target vehicles 102 that, from the perspective of the host vehicle 101, are objects or targets to be avoided and/or considered in vehicle 101 path planning and/or navigation.

The light transceiver 105, discussed further below with respect to FIG. 2, can provide light communications (referred to sometimes as “light-based communications”) between vehicles 101, one hundred to and/or an infrastructure element 150. In addition to the light transceiver 105, the vehicle can include other mechanisms, such as various radiofrequency transceivers, to allow the vehicle computer 110 to communicate with one or more infrastructure elements 150, other vehicles 102, and/or one or more remote computer servers (not shown), e.g., according to vehicle-to-vehicle or vehicle-to-infrastructure communications systems.

The computer 110 includes a processor and a memory such as are known. The memory includes one or more forms of computer-readable media, and stores instructions executable by the computer 110 for performing various operations, including as disclosed herein.

The computer 110 may operate a vehicle 101, 102 in an autonomous, a semi-autonomous mode, or a non-autonomous (or manual) mode. For purposes of this disclosure, an autonomous mode is defined as one in which each of vehicle 101, 102 propulsion, braking, and steering are controlled by the computer 110; in a semi-autonomous mode the computer 110 controls one or two of vehicle 101 propulsion, braking, and steering; in a non-autonomous mode a human operator controls each of vehicle 101 propulsion, braking, and steering.

The computer 110 may include programming to operate one or more of vehicle 101, 102 components 125, e.g., brakes, propulsion (e.g., control of acceleration in the vehicle by controlling one or more of an internal combustion engine, electric motor, hybrid engine, etc.), steering, climate control, interior and/or exterior lights, etc., as well as to determine whether and when the computer 110, as opposed to a human operator, is to control such operations. Additionally, the computer 110 may be programmed to determine whether and when a human operator is to control such operations.

The computer 110 may include or be communicatively coupled to, e.g., via a vehicle 101, 102 communications bus or other vehicle 101, 102 wired or wireless network, more than one processor, e.g., included in electronic controller units (ECUs) or the like included in the vehicle for monitoring and/or controlling various vehicle components 125, e.g., a powertrain controller, a brake controller, a steering controller, etc. The computer 110 is generally arranged for communications on a vehicle communication network that can include a communications bus in the vehicle such as a controller area network (CAN) or the like, and/or other wired and/or wireless mechanisms.

Via the vehicle 101, 102 network, the computer 110 may transmit messages to various devices in the vehicle and/or receive messages from the various devices, e.g., sensors 115, an actuator 120, an human machine interface (HMI), etc. Alternatively or additionally, in cases where the computer 110 actually comprises a plurality of devices, the vehicle 101, 102 communication network may be used for communications between devices represented as the computer 110 in this disclosure. Further, as mentioned below, various controllers and/or sensors 115 may provide data to the computer 110 via the vehicle communication network.

Vehicle 101, 102 sensors 115, in addition to light detectors that may be included in the light transceiver 105, may include a variety of devices such as are known to provide data to the computer 110. For example, the sensors 115 may include Light Detection And Ranging (LIDAR) sensor(s) 115, etc., disposed on a top of the vehicle 101, 102, behind a vehicle 101, 102 front windshield, around the vehicle 101, 102, etc., that provide relative locations, sizes, and shapes of objects surrounding the vehicle 101, 102. As another example, one or more radar sensors 115 fixed to vehicle 101, 102 bumpers may provide data to provide locations of the objects, second vehicles 102, etc., relative to the location of the vehicle 101, 102. The sensors 115 may further alternatively or additionally, for example, include camera sensor(s) 115, e.g. front view, side view, etc., providing images from an area surrounding the vehicle 101, 102, an ultrasonic sensor 115, etc.

The vehicle 101, 102 actuators 120 are implemented via circuits, chips, or other electronic and or mechanical components that can actuate various vehicle subsystems in accordance with appropriate control signals as is known. The actuators 120 may be used to control components 125, including braking, acceleration, and steering of a vehicle 101, 102.

In the context of the present disclosure, a vehicle component 125 is one or more hardware components, and any program instructions stored therein and/or executable thereby, that are adapted to perform a mechanical or electro-mechanical function or operation—such as moving the vehicle 101, 102, slowing or stopping the vehicle 102, steering the vehicle 101, 102, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a brake component, a park assist component, an adaptive cruise control component, an adaptive steering component, a movable seat, etc.

In addition, the computer 110 may be programmed and otherwise configured (e.g., with appropriate hardware interface(s)) for communicating via a vehicle-to-vehicle communication module or interface 130 with devices outside of the vehicle 101, 102, e.g., through wireless vehicular communication (e.g., vehicle-to-vehicle (V2V) communication, vehicle-to-infrastructure (V2I or V2X) communication, vehicle-to-cloud (V2C) communication, etc.), to an infrastructure node 150 (typically via direct radio frequency communications) and/or (typically via the network 135) a remote (i.e., external to the vehicle 101, 102 and in a geographic location out of a line of sight (also referred to as a sightline) of the vehicle 101, 102 and node 150) server 170. The module 130 could include one or more mechanisms by which the computers 110 of vehicles 102 may communicate, including any desired combination of wireless (e.g., cellular, wireless, satellite, microwave and radio frequency) communication mechanisms and any desired network topology (or topologies when a plurality of communication mechanisms are utilized). Exemplary communications that can be used for vehicle-to-vehicle (V2V) or vehicle-to-infrastructure (V2X) communications include cellular, Bluetooth, IEEE 802.11, dedicated short range communications (DSRC), and/or wide area networks (WAN), including the Internet, providing data communication services.

An infrastructure node or element 150 typically includes a physical structure such as a tower or other support structure (e.g., a pole, a box mountable to a bridge support, cell phone tower, road sign support, etc.) on which various hardware or equipment, including a light transceiver 105, and possibly various sensors, computers, etc., can be mounted, stored, and/or contained, and powered, etc. Because it is typically located near a road, the infrastructure element 150 can be referred to as a roadside infrastructure element. As with vehicles 101, 102, an infrastructure element 150 can include a computer controlling radiofrequency or other communications for exemplary communications as described above. One infrastructure node 150 is shown in FIG. 1 for ease of illustration, but the system 100 could and likely would include tens, hundreds, or thousands of nodes 150. The infrastructure node 150 is typically stationary, i.e., fixed to and not able to move from a specific geographic location. Infrastructure element 150 sensors, in addition to light detectors that may be included in a light transceiver 105, may include one or more sensors such as described above for the vehicle 105 sensors 115, e.g., LIDAR, radar, cameras, ultrasonic sensors, etc. Further, although not shown for ease of illustration, the infrastructure node 150 also includes a power source such as a battery, solar power cells, and/or a connection to a power grid.

A top view of an example light-based communications transceiver 105 is provided in FIG. 2. A transmitter 205 can be provided to send or transmit light-based communications, e.g., in a conventional manner. Light used for such communications can be in the visible or invisible spectrum. For example, the transmitter 205 could include an array of one or more light emitting diodes (LEDs), and a processor included in the transmitter 205 could be programmed to cause modulation of LED-generated light. The transmitter 205 can be provided on a rotatable platform 215. For example, a motor (not shown) can be provided to rotate the platform 215 so that the transmitter 205 can transmit light in multiple directions, e.g., in one example, in any direction over a range of 360 degrees. That is, the transmitter 205 may emit light on a beam having a width of only 1 to 2 degrees, but the motor can rotate the platform 215 through up to 360 degrees. Further, a receiving surface 210 can extend up to 360 degrees around a circumference or perimeter of the transceiver 105. The receiving surface 210 can include conventional photosensitive elements provided for extraction of data from a received modulated light beam.

Certain light-based communications discussed herein include a key. In the context of this disclosure, a “key” is a set of data that at a minimum can be used to verify or authenticate a source of a message. A key typically can also be used to specify how message content is to be extracted from raw data (typically a series of bits, i.e., a sequence of binary data in the form of a 1 or a 0) included in a message. Accordingly, a key typically includes three elements: a certificate, an encryption rule, and an encoding rule.

Some or all of a key (at a minimum, a certificate) can be provided to a vehicle 101, 102 from an infrastructure element 150. For example, the infrastructure element 150, as explained above, for V2X communications via a variety of protocols or communications media. A computer included in the infrastructure element 150 can be programmed to actuate V2X communications, e.g., to actuate radio frequency V2X communications to provide a key.

In one example, an infrastructure element 150 could periodically, e.g., once per minute, broadcast a message including a key, e.g., using V2X communications for vehicles 101, 102 within a reception area of the infrastructure element 150. For example, a computer included in or on the infrastructure element 150 could include programming to generate and transmit the key, e.g., via communications mechanisms in or on the infrastructure element 150. Thus, vehicles 101, 102 in a reception area of the infrastructure element 150 would receive a same key and could thus authenticate each other in light-based communications as described herein. To provide the key, a broadcast message from an infrastructure node 150 could include two elements, first, an infrastructure signature, and second, the key for vehicles 101, 102 to use for light-based communications as described herein. The infrastructure signature is typically a sequence of encrypted data that can be decrypted by authorized devices, e.g., vehicle computers 110. For example, a vehicle computer 110 could have an encryption/decryption key for an infrastructure signature stored in its memory, e.g., by a vehicle 101, 102 manufacture, by a service center, etc. Further, the key, or at least the certificate portion thereof, provided along with the infrastructure signature could be generated by a random or pseudo-random number generation technique to minimize the possibility of an unauthorized device guessing the key.

In the present context, a certificate or security certificate has the usual meaning given to these terms with respect to digital communications, i.e., a set of data that can be used to authenticate a message source. That is, a certificate typically includes a sequence of data, e.g., bytes, specified by a certificate of authority, e.g., a government or corporate agency, that can be checked to authenticate a message source.

An encryption rule specifies how message content, e.g., a payload, is extracted from raw data. Various encryption rules, including various conventional rules, may be used in the present context. These include rules such as XOR, bit jump, auto-encoder, etc. XOR is what is referred to as an additive cipher, requiring two data strings of equal length from which a payload can be extracted, i.e., the data strings having been encoded with a bitwise XOR (exclusive or) operation. Bit jump is an encoding technique in which a payload is obtained by resampling and original data set with specified bit steps. For example, in a two-bit jump, and original bit string could be 11010001, the real payload to be extracted being 1101. An auto encoder is a neural network model for converting raw data to a payload, where model parameters such as a number of layers and a type of layer in the neural network are included in the key.

An encoding rule is a rule that is used to convert a bit sequence into a structured message. Example encoding rules include LCM (least common multiple), PROTO (protocol buffer), ROS image, BER (basic encoding rule), and OER (octet encoding rules) encoding.

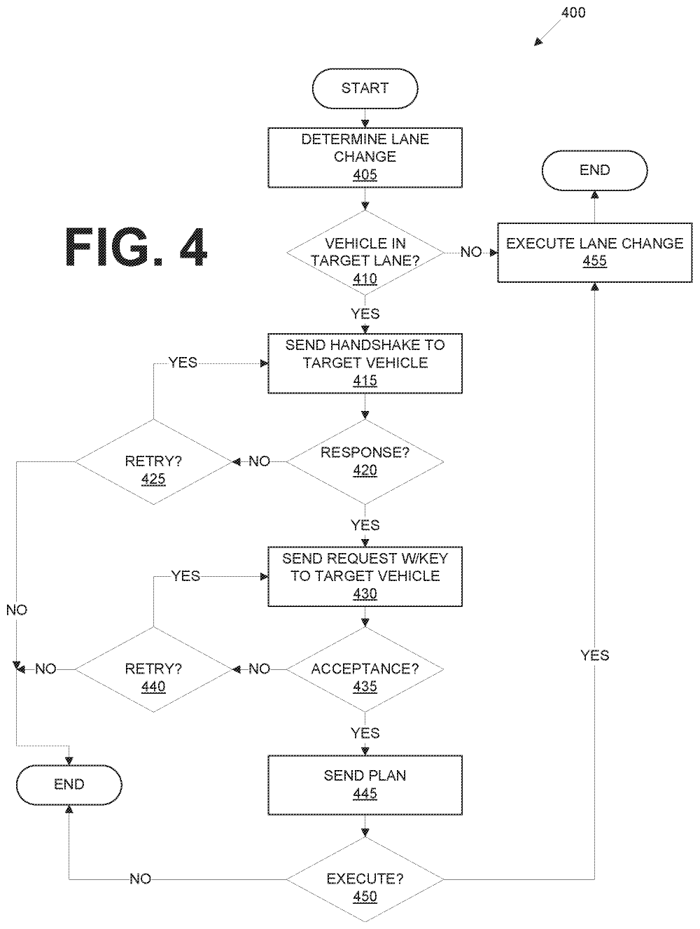

FIG. 4 is a diagram of an example process 400 for a host vehicle 101 to control a lane change including light-based communications. The process 400 can be executed by a processor of a computer 110 according to instructions stored in a memory of the computer 110, in combination with other components 125 of the vehicle 101 as discussed herein.

The process 400 can begin in a block 405, in which the computer 110 determines for the vehicle 101 to execute a lane change operation. For example, the computer 110 could receive operator input, e.g., via a human machine interface or the like, to perform a lane change operation and/or could determine based on a path planning algorithm or the like, to change lanes. Determining to change lanes typically includes specifying a target lane 140 from which the vehicle 101 is to move from a current lane 135.

Next, in a block 410, the computer 110 can determine whether a target vehicle 102 is detected, e.g., using conventional object detection algorithms based on data from sensors 115, in a target lane 140. If not, the process 400 proceeds to a block 455 to execute a lane change. Otherwise, the process 400 proceeds to a block 415.

In the block 415, the computer 110 causes actuation of the host vehicle 101 light transceiver 105 to transmit a handshake message to a vehicle 102 in an adjacent target lane 140. As mentioned above, a light transceiver 105 is typically configured to transmit light-based messages directionally. Further, the purpose of the handshake message is to establish communications between the host vehicle 101 and a specified target vehicle 102. Therefore, the computer 110 can cause actuation of the light transceiver 105 to move the platform 215 so that the transmitter 205 is oriented or aimed in a direction to communicate with a specified target vehicle 102.

The handshake message is typically an unencrypted message encoded in a sequence of bits. Vehicles 101, 102 included in the system 100 could include computers 110 programmed to encode and decode handshake messages according to a specified set of one or more encoding/decoding rules. The handshake message can include basic information for establishing light-based communications between vehicles 101, 102, such as identifying information for each vehicle 101, 102. For example, a host vehicle 101 could transmit a handshake message including a make, model, color, vehicle identification number, etc., of the host vehicle 101 to a target vehicle 102. The target vehicle 102 receiving the handshake message could then provide a responsive handshake message with similar identifying data of the target vehicle 102. Additionally, a host vehicle 101 handshake message could include identifying information for the specified target vehicle 102, whereupon a target vehicle 102 may respond only if it is the vehicle identified by the received identifying target vehicle 101 to information.

Following the block 415, the computer 110 determines whether a responsive handshake message has been received from the target vehicle 102 to which the handshake message was sent in the block 415. If not, the process 400 proceeds to a block 425. If a responsive handshake message was received, then the process 400 proceeds to a block 430. The computer 110 can determine whether a responsive handshake message is received based on decoding light pulses received in the light transceiver 105, and determining that a payload of the responsive handshake message confirms receipt and/or provides identifying information of the specified target vehicle 102.

In the block 425, the computer 110 determines whether to retry, i.e., resend, the handshake message. For example, a specified period of time may have elapsed, the computer 110 may determine that a lane change is no longer included in a path planning algorithm, user input could be received to cancel or and a lane change operation, etc. If the handshake message is not to be resent, then the process 400 ends. Otherwise, the process 400 returns to the block 415.

After the block 420, the handshake message having been sent and acknowledged, further messages in the process 400 can be sent with a secure key as described above. For example, in the block 430, the computer 110 sends a lane change request along with a key (including a certificate, and encoding rule, and encryption rule as described above) to the target vehicle 102. The lane change request can be encrypted and encoded as specified in the key, and in addition to the key can include a request from the host vehicle 101 to change into a target lane 140 in which the target vehicle 102 is currently traveling. Further, a lane change request can specify information such as a planned speed at which the host vehicle 101 will travel when changing lanes, whether the host vehicle 101 plans to move in front of or behind the target vehicle 102, etc.

Next, in a block 435, the computer 110 determines whether a message has been received from a vehicle 102 accepting the lane change request of the block 430. If not, e.g., if a negative response is received or if no response is received within a specified amount of time, e.g., two seconds, then the process 400 proceeds to a block 440. Otherwise, the process 400 proceeds to a block 445.

In the block 440, the computer 110 determines whether to retry sending the lane change request, e.g., if a negative response was received in the block 435, if the computer 110 and/or a vehicle 101 operator has canceled the lane change request, or a specified period of time has elapsed, then the computer 110 may determine not to retry the lane change request, whereupon the process 400 ends. Otherwise, the process 400 returns to the block 430 following the block 440.

In the block 445, the computer 110 causes actuation of the light transceiver 105 to send a lane change plan to the target vehicle 102. Some or all of the lane change plan may have been sent in the message described above with respect to the block 430, although some or all of the data in the lane change plan may have been updated since the block 430. For example, a lane change plan can include a time at which the vehicle 101 will move from a current lane 135 to a target lane 140, a speed at which the vehicle 101 will be moving, whether the vehicle 101 will move to the front or to the rear of a vehicle 102, etc.

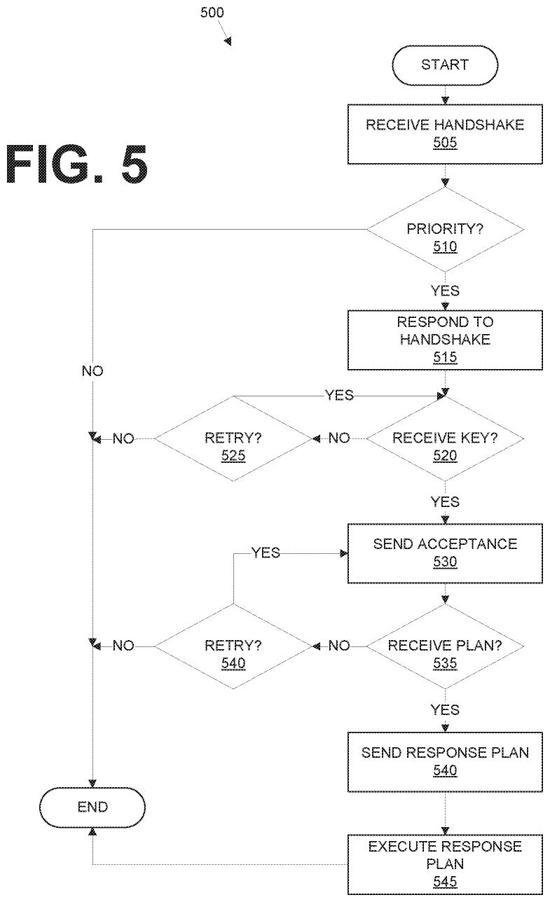

In the block 450, the computer 110 determines whether to execute the lane change plan. For example, a message could be received from a target vehicle 102 and/or an infrastructure element 150 specifying not to carry out a lane change, or the target vehicle 102 could fail to send a response plan as discussed below with respect to FIG. 5. The target vehicle 102 could determine that its path plan no longer supports the lane change planned by the host vehicle 101, e.g., because of a need to break or accelerate based on other target vehicles 102. Further, an infrastructure element 150 could broadcast a message via either a light transceiver 105 or some other mechanism such as radio-based V2X communications, indicating that a priority vehicle 102 is traveling in a target lane 140 and/or is moving to a target lane 140, thereby overriding the lane change plan of the host vehicle 101. If the computer 110 determines not to execute the lane change, then the process 400 ends. Otherwise, the process 400 proceeds to the block 455.

In the block 455, the computer 110 causes actuators 120 to operate to actuate vehicle 101 components 125, e.g., steering, propulsion, and/or braking, to execute the planned lane change, and to do so in accord with a response plan provided from a vehicle 102. For example, a lane change could be executed at a vehicle 101 speed according to a speed specified in a vehicle 102 response plan. Similarly, a lane change could be executed at a time specified in a vehicle 102 response plan. Following the block 455, the process 400 ends.

FIG. 5 is a diagram of an example process 500 for a target vehicle 102 to provide light-based communications for a host vehicle 101 to control a lane change including light-based communications. The process 500 can be executed by a processor of a target vehicle 102 computer 110 according to instructions stored in a memory of the computer 110, in combination with other components 125 of the vehicle 102 as discussed herein.

The process 500 begins in a block 505, in which a target vehicle 102 receives a handshake message, e.g., such as described above, from a host vehicle 101.

Next, in a block 510, a target vehicle 102 computer 110 determines whether a priority directive or rule prevents a lane change as requested by the host vehicle 101. For example, a detected emergency vehicle 102 in a same lane as the target vehicle 102 could warrant priority over the host vehicle 101, and upon detecting such emergency vehicle 102 a target vehicle 102 computer 110 could be programmed reject a handshake message from the host vehicle 101. Alternatively or additionally, a priority vehicle 102, such as an emergency vehicle, and/or an infrastructure element 150 could send, e.g., via V2V or V2X communications, a message specifying that the target vehicle 102 is to give priority to another target vehicle 102 four usage of a target lane 140. If priority is to be given, then the process 500 ends. Otherwise, the process 500 proceeds in a block 515.

In the block 515, the target vehicle 102 responds to the handshake message, e.g., in a form as described above.

Next, in a block 520, the target vehicle 102 determines whether it received a recognized key from the host vehicle 101. As explained above, the host vehicle 101 can include a key in a light-based communication to the target vehicle 102. The key can include a security certificate that the target vehicle 102 can authenticate using conventional techniques. The target vehicle 102 computer 110 can further verify that the key includes rules for decrypting and decoding the received message. If a key is received, then the process 500 proceeds to a block 530. Otherwise, the process 500 proceeds to a block 525.

In the block 525, the target vehicle 102 computer 110 determines whether to wait further to receive a message including a key from the host vehicle 101. For example, the target vehicle 102 could receive a message indicating that another vehicle 102 now has priority and the target lane 140, could alter its path plan so as to be unable to negotiate a lane change with the host vehicle 101, a specified period of time, e.g., two seconds, have elapsed, etc. If the computer 110 determines to wait for a message including a key, then the process 500 returns to the block 520. Otherwise, the process 500 ends.

In the block 530, the target vehicle 102 computer 110 actuates its light-based transceiver 105 to send an acceptance, e.g., as described above, to the host vehicle 101. For example, the computer 110 could be operating the vehicle 102 autonomously or semi-autonomously, and could determine to incorporate a lane change request from the host vehicle 101 into a path plan of the target vehicle 102. Alternatively or additionally, a human operator of the target vehicle 102 could receive a message via a vehicle 102 human machine interface (HMI) or the like specifying the lane change request, and could provide input to accept or reject it. Although the block 530 is not illustrated as a decision block, it should be noted that the vehicle 102 computer 110 could decline to provide an acceptance of the lane change request from the host vehicle 101, e.g., as just described.

Next, in a block 535, the target vehicle 102 computer 110 determines whether it has received a lane change plan from the host vehicle 102. If not, the process 500 proceeds to a block 540. Otherwise, the process 500 proceeds to a block 540.

In the block 540, the target vehicle 102 determines whether to wait further to receive a message including a lane change plan from the host vehicle 101, e.g., as described above concerning the block 525. If it is determined not to wait further, then the process 500 ends. Otherwise, the process 500 returns to the block 535.

In the block 540, the vehicle 102 computer 110 causes actuation of the light-based transceiver 105 two send the response plan. The response plan may simply be confirmation that the vehicle 102 will operate in a manner consistent with the plan provided from the vehicle 101. For example, the response plan may specify that the vehicle 102 will maintain a speed, or will decrease or increase a speed to allow the vehicle 101 two move to a space behind or in front of the vehicle one or two, etc.

Next, in a block 545, the vehicle 102 computer 110 causes actuators 120 of vehicle 102 components to operate to execute the response plan, e.g., to steer, accelerate, and/or brake as specified to facilitate the lane change by the host vehicle 101. Following the block 545, the process 500 ends.

### CONCLUSION

As used herein, the adverb “substantially” means that a shape, structure, measurement, quantity, time, etc. may deviate from an exact described geometry, distance, measurement, quantity, time, etc., because of imperfections in materials, machining, manufacturing, transmission of data, computational speed, etc.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computers and computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Python, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

Memory may include a computer-readable medium (also referred to as a processor-readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system, comprising a computer including a processor and a memory, the memory storing instructions executable by the processor to:
upon a determination to execute a lane change, send a light-based request communication, including a security key, to a target vehicle to negotiate the lane change; and
upon receiving a light-based response communication from the target vehicle, execute the lane change.

2. The system of claim 1, wherein the security key includes a security certificate, an encoding rule, and an encryption rule.

3. The system of claim 1, the instructions further comprising instructions to receive at least a certificate in the security key from a roadside infrastructure element.

4. The system of claim 3, the instructions further comprising instructions to verify a signature received along with the security key from the roadside infrastructure element.

5. The system of claim 1, further comprising a roadside infrastructure element including a second computer including a second processor and a second memory, the second memory storing second instructions executable by the processor to generate and transmit the security key.

6. The method of claim 1, wherein the security key was provided by non-light-based communications.

7. The system of claim 1, the instructions further comprising instructions to, prior to sending the light-based request communication, send a light-based handshake message.

8. The system of claim 1, the instructions further comprising instructions to send a lane change plan via light-based communications.

9. The system of claim 8, the instructions further comprising instructions to receive a response to the lane change plan via light-based communications.

10. The system of claim 1, the instructions further comprising instructions to cancel the lane change upon determining that a second target vehicle has priority in a target lane.

11. A method, comprising:
upon a determination to execute a lane change, sending a light-based request communication, including a security key, to a target vehicle to negotiate the lane change; and
upon receiving a light-based response communication from the target vehicle, executing the lane change.

12. The method of claim 11, wherein the security key includes a security certificate, an encoding rule, and an encryption rule.

13. The method of claim 11, further comprising receiving at least a certificate in the security key from a roadside infrastructure element.

14. The method of claim 13, further comprising verifying a signature received along with the security key from the roadside infrastructure element.

15. The method of claim 11, further comprising generating and transmitting the security key from a roadside infrastructure element.

16. The method of claim 11, wherein the security key was provided by non-light-based communications.

17. The method of claim 11, further comprising, prior to sending the light-based request communication, sending a light-based handshake message.

18. The method of claim 11, further comprising sending a lane change plan via light-based communications.

19. The method of claim 18, further comprising receiving a response to the lane change plan via light-based communications.

20. The method of claim 11, further comprising canceling the lane change upon determining that a second target vehicle has priority in a target lane.
